(19) United States
(12) Patent Application Publication
(10) Pub. No.: US 2021/0179376 A1
(43) Pub. Date: Jun. 17, 2021

(54) CONVEYING APPARATUS AND PRINTING APPARATUS

(71) Applicant: BROTHER KOGYO KABUSHIKI KAISHA, Nagoya (JP)

(72) Inventor: Yoshiya TOMATSU, Kasugai-shi (JP)

(21) Appl. No.: 17/120,690

(22) Filed: Dec. 14, 2020

(30) Foreign Application Priority Data
Dec. 16, 2019 (JP) 2019-226742

(51) Int. Cl. B65H 16/10; B65H 20/02; B41J 15/04

(52) U.S. Cl. CPC B65H 16/103; B41J 15/04; B65H 20/02

(57) ABSTRACT

A conveying apparatus includes: a casing; a motor; a supporting part; a first shaft; a rotary body rotating about an axis of the first shaft; a driving transmitting part transmitting a driving force from the motor to the rotary body; a holder supporting a roll of a continuous sheet, being detachably attached to the first shaft, and rotating about the axis of the first shaft; a rotation transmitting part transmitting rotation of the rotary body to the holder; and a conveyor conveying the continuous sheet. The holder includes: a second shaft inserted into the roll of the continuous sheet, and a joint, on one end of the second shaft, attaching the second shaft to the first shaft detachably such that the second shaft is coaxially with the first shaft; and in an attached state, the rotation transmitting part connects the second shaft to the first shaft or the rotary body.

### CROSS REFERENCE TO RELATED APPLICATION

The present application claims priority from Japanese Patent Application No. 2019-226742, filed on Dec. 16, 2019, the disclosure of which is incorporated herein by reference in its entirety.

### BACKGROUND

### Field of the Invention

The present disclosure relates to a conveying apparatus which conveys a continuous sheet wound in a roll, and a printing apparatus which is provided with the conveying apparatus and which performs printing on the sheet.

### Description of the Related Art

There is known a conveying apparatus in which a roll body (a roll of a continuous sheet) which is a sheet (a continuous sheet) wound in a roll is arranged inside of the conveying apparatus and which conveys the sheet in the inside of the conveying apparatus. For example, Japanese Patent Application Laid-open No. 2000-355448 discloses an image forming apparatus in which a roll body is arranged in the inside of a casing of the image forming apparatus and which performs printing on a sheet that is drawn from the roll body and is conveyed. Japanese Patent Application Laid-open No. H07-215548 corresponding to U.S. Pat. No. 5,717,495 discloses a facsimile apparatus having a similar configuration to that of the above-described image forming apparatus.

In the conveying apparatus (the image forming apparatus and the facsimile apparatus) disclosed in Japanese Patent Application Laid-open No. 2000-355448 and Japanese Patent Application Laid-open No. H07-215548 corresponding to U.S. Pat. No. 5,717,495, in a case that the roll body is replaced or exchanged, the roll body is detached and attached with respect to the casing, along a radial direction of the roll body.

In the inside of the casing of the conveying apparatus having the above-described configuration, a space for allowing the roll body to pass is required in the radial direction of the roll body in a case that the roll body is to be exchanged. In such a conveying apparatus, there is such a fear that the roll body and a part might interfere with each other in the case that the roll body is exchanged. Accordingly, it is not possible to arrange any part in the space for allowing the roll body to pass therethrough. Therefore, since a part required for the apparatus cannot be arranged in the vicinity of a space in which the roll body is installed, it is not possible to make the size of the apparatus to be small. Accordingly, the part cannot be arranged at a reasonable location or position due to the space required for allowing the roll body to pass therethrough, which in turn leads to any increase in the size of the apparatus.

The present disclosure has been made in view of the above-described circumstance, and an object of the present disclosure is to provide a conveying apparatus capable of realizing a compact or small-sized casing while securing a space required for attaching/detaching the roll body.

### SUMMARY

According to a first aspect of the present disclosure, there is provided a conveying apparatus including:

a casing;

a motor;

a supporting part positioned in the casing;

a first shaft supported by the supporting part;

a rotary body configured to rotate about an axis of the first shaft;

a driving transmitting part configured to transmit a driving force from the motor to the rotary body;

a holder configured to support a roll of a continuous sheet in which a continuous sheet is wound, configured to be detachably attached to the first shaft, and configured to rotate about the axis of the first shaft;

a rotation transmitting part configured to transmit rotation of the rotary body to the holder; and

a conveyor positioned in the casing and configured to convey the continuous sheet,
wherein the holder includes:
   a second shaft configured to be inserted into the roll of the continuous sheet, and
   a joint positioned on one end of the second shaft, configured to move along the axis of the first shaft, and configured to attach the second shaft to the first shaft detachably such that the second shaft is coaxially with the first shaft; and

in an attached state in which the second shaft is attached to the first shaft, the rotation transmitting part connects the second shaft to the first shaft or the rotary body so as to transmit the rotation of the rotary body to the second shaft.

According to a second aspect of the present disclosure, there is provided a printing apparatus including:

the conveying apparatus as defined in the first aspect; and

a printing part configured to perform printing on the continuous sheet conveyed by the conveyor.

### BRIEF DESCRIPTION OF THE DRAWINGS

FIG. 1 is a perspective view depicting the outer appearance of an image recording apparatus according to an embodiment of the present disclosure.

FIG. 2 is a vertical cross-sectional view depicting a II-II cross-section of FIG. 1.

FIG. 3A is a rear view of a supporting mechanism, and FIG. 3B is a right side view of the supporting mechanism.

FIG. 4 is a perspective view of the supporting mechanism, an install part and a holder as seen from a left rear side thereof.

FIG. 5 is a perspective view of the supporting mechanism, the install part and the holder as seen from a right rear side thereof.

FIG. 6 is a vertical cross-sectional view depicting a VI-VI cross-section of FIG. 5.

FIG. 7 is a rear view of the supporting mechanism, the install part and the holder.

FIG. 8 is a perspective view of the holder.

FIG. 9 is a vertical cross-sectional view depicting a IX-IX cross-section of FIG. 4.

FIG. 10 is a vertical cross-sectional view depicting a X-X cross-section of FIG. 7.

### DESCRIPTION OF THE EMBODIMENTS

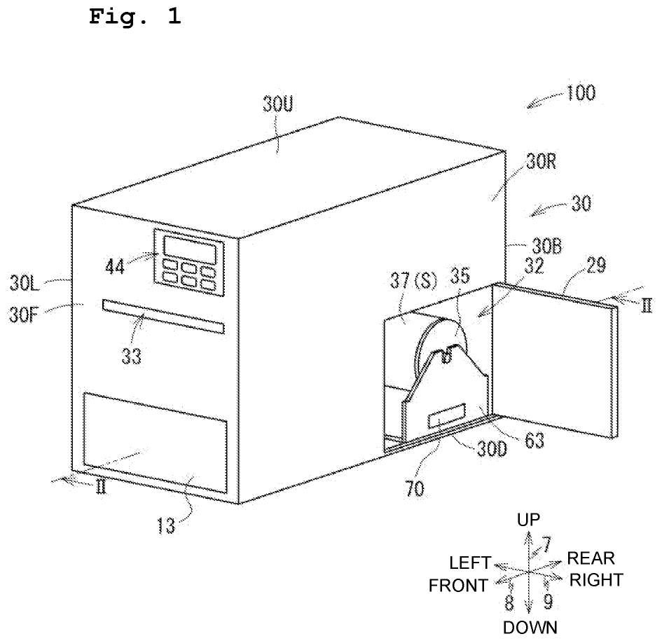

An image recording apparatus 100 according to an embodiment of the present disclosure will be explained below. Note that an embodiment which is to be explained below is merely an example of the present disclosure; it is needless to say that the embodiment can be appropriately changed within a range not changing the gist of the present disclosure. Further, in the following explanation, advancement or movement (progress) directed from a starting point to an end point of an arrow is expressed as an “orientation”, and going forth and back on a line connecting the starting point and the end point of the arrow is expressed as a “direction”. Further, in the following description, an up-down direction 7 is defined, with a state in which the image recording apparatus 100 is usably or operably installed (the state of FIG. 1) as the reference; a front-rear direction 8 is defined, with a side on which a discharge port 33 is provided being defined as a front side (front surface); and a left-right direction 9 is defined, with the printing apparatus 100 as seen from the front side (front surface). The up-down direction 7, the front-rear direction 8, and the left-right direction 9 are orthogonal to each other.

<Configuration of Outer Appearance of Image Recording Apparatus 100>

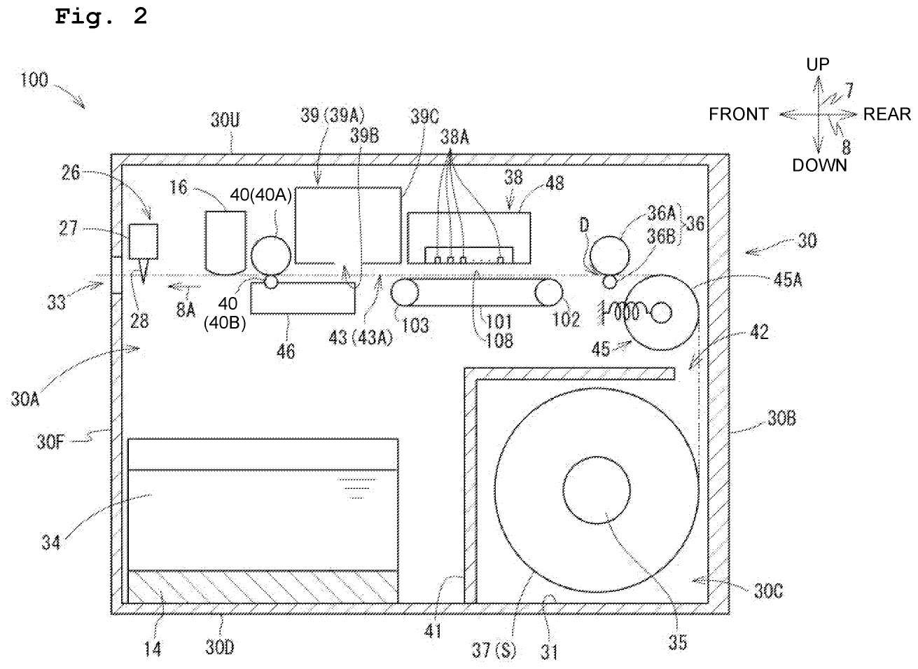

The image recording apparatus 100 (an example of a “conveying apparatus” and a “printing apparatus”) as depicted in FIG. 1 records, in the ink-jet recording system, an image on a sheet S forming a roll body (a roll of a continuous sheet) 37 (see FIG. 2).

As depicted in FIG. 1, the image recording apparatus 100 includes a casing 30. The casing 30 has a substantially rectangular parallelepiped shape and has a size placeable or arrangeable on a table or desk. That is, the image recording apparatus 100 is suitable for use by being placed on the table or desk. Of course, the image recording apparatus 100 may be used while being placed on a floor surface or a rack.

The casing 30 has a right surface 30R and a left surface 30L, an upper surface 30U and a lower surface 30D, and a front surface 30F and a rear surface 30B. With this, an internal space 30A (see FIG. 2) of the casing 30 is partitioned from the outside. The right surface 30R and the left surface 30L are located away from each other in the left-right direction 9. The upper surface 30U connects an upper end of the right surface 30R and an upper end of the left surface 30L. The lower surface 30D connects a lower end of the right surface 30R and a lower end of the left surface 30L. The front surface 30F and the rear surface 30B are located apart from each other in the front-rear direction 8.

As depicted in FIG. 1, a slit-shaped discharge port 33 which is long in the left-right direction 9 is formed in the front surface 30F of the casing 30. A sheet S (see FIG. 2), on which the image recording has been performed is discharged from the discharge port 33.

An operation panel 44 is provided on the front surface 30F of the casing 30. A user performs, via the operation panel 44, input for operating the image recording apparatus 100 and/or input for confirming a variety of kinds of settings.

<Internal Configuration of Image Recording Apparatus 100>

As depicted in FIG. 2, respective constitutive elements, of the image recording apparatus 100, such as a holder 35, a tensioner 45, a conveying roller pair 36, a conveying roller pair 40, a conveying belt 101, a head 38 (an example of a “printing part”), a fixing part 39, a supporting member 46, a CIS 16, a cutter unit 26, a tank 34, etc., are arranged in the internal space 30A. The conveying roller pair 36, the conveying roller pair 40, and conveyor belt 101 are an example of a “conveyor”.

A partition wall 41 is provided in the internal space 30A. The partition wall 41 partitions a rear lower part of the internal space 30A so as to define a sheet accommodating space 30C. The sheet accommodating space 30C is a space which is surrounded by the partition wall 41 and the casing 30 (specifically, the rear surface 30B, the lower surface 30D, the right surface 30R, and the left surface 30L) and which is isolated from the head 38, etc.

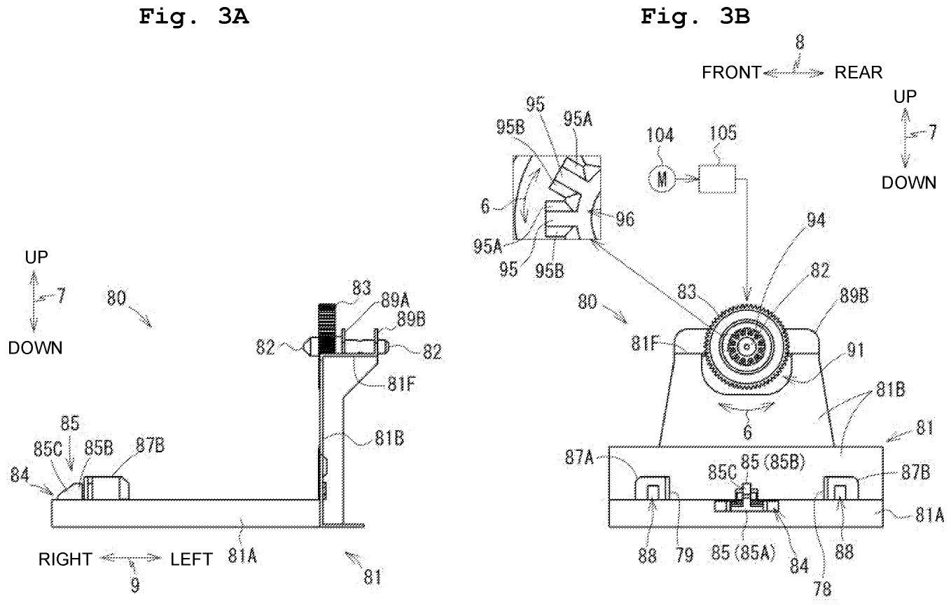

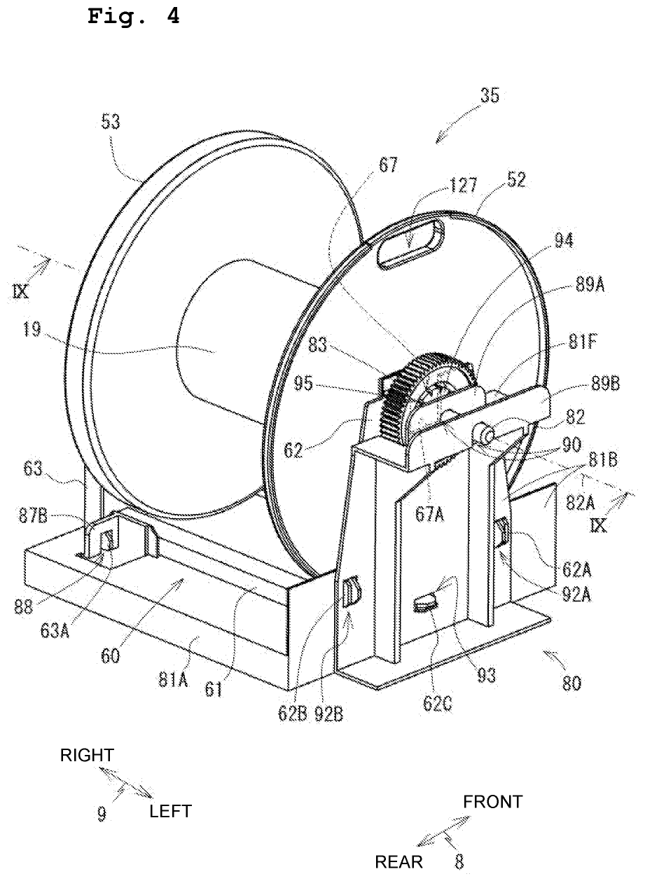

The sheet accommodating space 30C accommodates a roll body 37, a holder 35 supporting the roll body 37, and an install part 60 (see FIG. 4) in which the holder 35 is installed. The install part 60 is installed (see FIG. 4) in a supporting mechanism 80 (see FIG. 3) which is arranged in the sheet accommodating space 30C. With this, the roll body 37, the holder 35 and the install part 60 are positioned in the sheet accommodating space 30C.

The roll body (the roll of the continuous sheet) 37 has a core tube 19 (see FIG. 4) and a sheet S (a continuous sheet S) which is continuous and long. The sheet S is wound around the core tube 19 in a roll shape in the circumferential direction of the axial core of the core tube 19. Note that in FIG. 4, only the core tube 19 of the roll body 37 is depicted, and the sheet S is not depicted. The core tube 19 is installed in the holder 35, to thereby allow the roll body 37 to be supported by the holder 35. Note that it is allowable that the roll body 37 does not have the core tube 19, and that the sheet S is wound in a roll shape so that the sheet is installable in the holder 35. The holder 35, the install part 60 and the supporting mechanism 80 will be explained in detail later on.

As depicted in FIG. 1, a right cover 29 is positioned in the right surface 30R of the casing 30. In a case that the right cover 29 is opened, the holder 35, etc., positioned in the inside of the sheet accommodating space 30C is exposed thereby, via an opening 32 formed in the right surface 30R of the casing 30. In a case that the right cover 29 is closed, the holder 35, etc., positioned in the inside of the sheet accommodating space 30C is shielded thereby. Note that in FIG. 1, although the casing 30 is opened/closed by the rotation of the right cover 29, it is allowable that the casing 30 is opened/closed by, for example, sliding of the right cover 29, rather than the rotation of the right cover 29.

As depicted in FIG. 2, the sheet accommodating space 30C is opened upward at a rear part of the sheet accommodating space 30C. More specifically, a gap 42 is defined between the partition wall 41 and the rear surface 30B, that is, at a location above a rear end of the roll body 37. In a case that the conveying roller pairs 36 and 40 are rotated, the sheet S is thereby drawn upward from the rear end of the roll body 37 and is guided to the tensioner 45 via the gap 42.

The tensioner 45 is positioned in the rear part of the internal space 30A, at a location above the partition wall 41. The tensioner 45 has a rotatable roller, and a rearward biasing force is applied to the roller by a biasing member such as a spring, etc. The roller of the tensioner 45 has an outer circumferential surface 45A facing the outside of the casing 30. The outer circumferential surface 45A has a size which is not less than the maximum width of the sheet S in the left-right direction 9. An upper end of the outer circumferential surface 45A is at a position which is substantially same, in the up-down direction 7, as a nip D of the conveying roller pair 36.

The sheet S pulled out from the roll body 37 is put or placed on and makes contact with the outer circumferential surface 45A. The sheet S is curved forward along the outer circumferential surface 45A, extends in a conveying orientation 8A, and is guided to the conveying roller pair 36. The conveying orientation 8A is a forward orientation along the front-rear direction 8. The tensioner 45 imparts a tension to the sheet S in a well-known method.

Note that the tensioner 45 is not limited to or restricted by the configuration depicted in FIG. 2, namely the configuration which imparts the rearward biasing force to the roller by a biasing member such as a spring, etc.; it is allowable to apply other well-known technique to the tensioner 45.

The conveying roller pair 36 is positioned in front of the tensioner 45. The conveying roller pair 36 has a conveying roller 36A and a pinch roller 36B. The conveying roller 36A and the pinch roller 36B make contact with each other at a position in the up-down direction 7 which is substantially same as the upper end of the outer circumferential surface 45A, to thereby form the nip D.

The conveying roller pair 40 is positioned in front of the conveying roller pair 36. The conveying roller pair 40 has a conveying roller 40A and a pinch roller 40B. The conveying roller 40A and the pinch roller 40B make contact with each other at a position in the up-down direction 7 which is substantially same as the upper end of the outer circumferential surface 45A, to thereby form a nip.

The conveying rollers 36A and 40A rotate by the driving force transmitted thereto from a motor 104 (see FIG. 3). The conveying roller pair 36 rotates while nipping the sheet S extending in the conveying orientation 8A from the tensioner 45, to thereby feed out the sheet S in the conveying orientation 8A along a conveying surface 43A. The conveying roller pair 40 rotates while nipping the sheet S fed from the conveying roller pair 36, to thereby feed out the sheet S in the conveying orientation 8A. Further, by the rotations of the conveying roller pairs 36 and 40, the sheet S is drawn from the sheet accommodating space 30C, passing the gap 42, toward the tensioner 45.

As depicted in FIG. 2, a conveyance path 43 extending from the upper end of the outer circumferential surface 45A of the tensioner 45 and arriving at the discharge port 33 is formed in the internal space 30A. The conveyance path 43 extends substantially linearly along the conveying orientation 8A, and is a space in which the sheet S can pass. Specifically, the conveyance path 43 is along a conveying surface 43A which spreads in the conveying orientation 8A and in the left-right direction 9 and which is long in the conveying orientation 8A. Note that in FIG. 2, the conveying surface 43A is indicated by a two-dot chain line indicating the conveyance path 43. The conveyance path 43 is defined by non-illustrated guide members located away from each other in the up-down direction 7 (not depicted in the drawings), the head 38, the conveying belt 101, the supporting member 46, the fixing part 39, etc. That is, the head 38, the conveying belt 101, the supporting member 46, and the fixing part 39 are positioned along the conveyance path 43.

The conveying belt 101 is positioned at a location below the conveyance path 43 and is positioned on the downstream side in the conveying orientation 8A with respect to the conveying roller pair 36. The conveying belt 101 is an endless belt. The conveying belt 101 is stretched between a driving roller 102 and a driven roller 103. The conveying belt 101 is arranged in the inside of the conveyance path 43 in the left-right direction 9. The driving roller 102 and the driven roller 103 are rotatably supported by a non-illustrated frame. The driving roller 102 and the driven roller 103 are spaced apart from each other in the front-rear direction 8 (conveying orientation 8A). The driving roller 102 is rotated by a driving force transmitted thereto from the motor 104 (see FIG. 3). The driven roller 103 rotates accompanying with the rotation of the driving roller 102. Thus, the conveying belt 101 conveys the sheet S which is supported thereby in the conveying orientation 8A.

The head 38 is positioned or located at the downstream side in the conveyance orientation 8A with respect to the conveying roller pair 36. The head 38 is positioned at a location above the conveyance path 43. Namely, the head 38 faces or is opposite to the conveyance path 43 in the up-down direction 7. Further, the head 38 faces the conveying belt 101, with the conveyance path 43 being interposed therebetween. The head 38 has a plurality of nozzles 38A. From the plurality of nozzles 38A, an ink is discharged or ejected downward toward the sheet S supported by the conveying belt 101. As a result, an image is recorded on the sheet S.

The fixing part 39 is positioned at a location above the conveyance path 43. Further, the fixing part 39 is positioned on the downstream side in the conveying orientation 8A with respect to the head 38 and is positioned on the upstream side in the conveying orientation 8A with respect to the conveying roller pair 40. The fixing part 39 is a UV radiator (ultraviolet light radiator) having a substantially rectangular parallelepiped shape which is elongated in the left-right direction 9. The fixing part 39 has a casing 39A. An opening 39B extending along the left-right direction 9 is formed in a lower wall of the casing 39A. The fixing part 39 radiates an ultraviolet light through the opening 39B onto the sheet S and/or the ink on the sheet S passing immediately below the opening 39B. In the present embodiment, the ink contains a resin which is cured by the ultraviolet light. Therefore, the ink irradiated with the ultraviolet light is fixed to the sheet S.

Note that the fixing part 39 is not limited to being the UV irradiator. For example, the fixing part 39 may be a halogen heater having a substantially rectangular parallelepiped shape which is elongated in the left-right direction 9. In such a case, the fixing part 39 radiates an infrared light via the opening 39B and heats the sheet S and/or the ink on the sheet S passing immediately below the opening 39B. Thus, the ink is fixed on the sheet S. In this case, it is allowable that the ink does not contain a resin which is cured by the ultraviolet light.

The supporting member 46 is positioned below the conveyance path 43. The supporting member 46 is located on downstream side in the conveying orientation 8A with respect to the head 38 and the conveying belt 101. A rear part of the supporting member 46 faces or is opposite to the fixing part 39. A front part of the supporting member 46 faces the conveying roller 40A. The supporting member 46 supports the sheet S which has been conveyed in the conveying orientation 8A by the conveying belt 101.

The CIS (Contact Image Sensor) 16 is positioned at a location above the conveyance path 43, and is positioned on the downstream side in the conveyance orientation 8A with respect to the conveying roller pair 40. In the CIS 16, a light is emitted from an light source such as an LED; a light reflected by the sheet is collected to a line sensor by a graded index lens; and an electric signal corresponding to the intensity of the reflected light received by the line sensor is outputted. This allows the CIS 16 to read an image of a printed surface of the sheet. The CIS 16 is arranged so that a read-line extends in the left-right direction 9.

The cutter unit 26 is located on the downstream side in the conveying orientation 8A with respect to the CIS 16, at a location above the conveyance path 43. In the cutter unit 26, a cutter 28 is mounted on a cutter carriage 27. The cutter carriage 27 moves in the conveyance path 43 in the left-right direction 9, by a non-illustrated belt-driving mechanism, etc. The cutter 28 is positioned so as to cross the conveyance path 43 in the up-down direction 7; accompanying with the movement of the cutter carriage 27, the cutter 28 moves in the conveyance path 43 in the left-right direction 9. By the movement of the cutter 28, the sheet S located in the conveyance path 43 is cut along the left-right direction 9.

The tank 34 stores the ink. The ink is a liquid containing a pigment, etc. The ink has a viscosity suitable for uniformly dispersing the pigment. The pigment is a component which serves as the color of the ink, namely, is a colorant contained in the ink. The ink is supplied from the tank 34 to the head 38 through a non-illustrated tube. The tank 34 is detachably attachable (attachable/detachable) with respect to the casing 30, via an openable/closable front cover 13 (see FIG. 1) provided on the front surface 30F of the casing 30. Note that the tank 34 may be fixed to the casing 30.

<Supporting Mechanism 80>

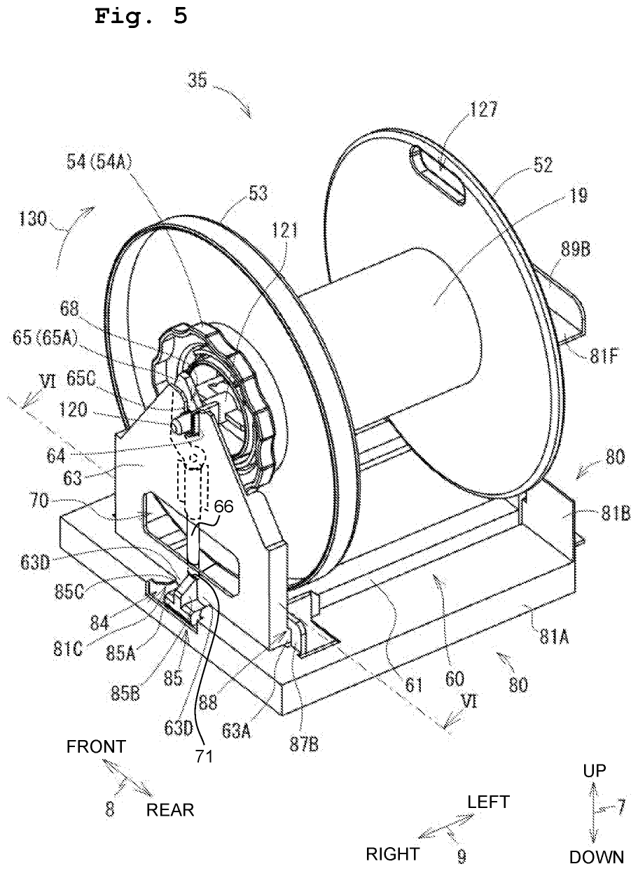

The supporting mechanism 80 supports the holder 35. In the present embodiment, as depicted in FIGS. 4 and 5, the holder 35 installed in the install part 60 is supported by the supporting mechanism 80. The supporting mechanism 80 depicted in FIG. 3 is arranged in the sheet accommodating space 30C (see FIG. 2). As depicted in FIG. 3, the supporting mechanism 80 is provided with a frame 81 (an example of a “supporting part”), a shaft 82 (an example of a “first shaft”) and a gear 83 (an example of a “rotary body”).

As depicted in FIG. 3, the frame 81 is constructed of a bottom plate 81A and a side plate 81B. The bottom plate 81A spreads in the front-rear direction 8 and the left-right direction 9, and is fixed to a bottom surface 31 (see FIG. 2) of the casing 30. The side plate 81B spreads in the up-down direction 7 and the front-rear direction 8, and is provided to stand upward from a left end part of the bottom plate 81A. The side plate 81B faces or is opposite to the opening 32 (see FIG. 1) in the left-right direction 9. Namely, the bottom plate 81A is positioned, in the left-right direction 9, between the side plate 81B and the opening 32. In the present embodiment, although the bottom plate 81A and the side plate 81B are integrally formed, it is allowable that the bottom plate 81A and the side plate 81B are formed as separate bodies, respectively, and are connected to each other by, for example, a screw, etc.

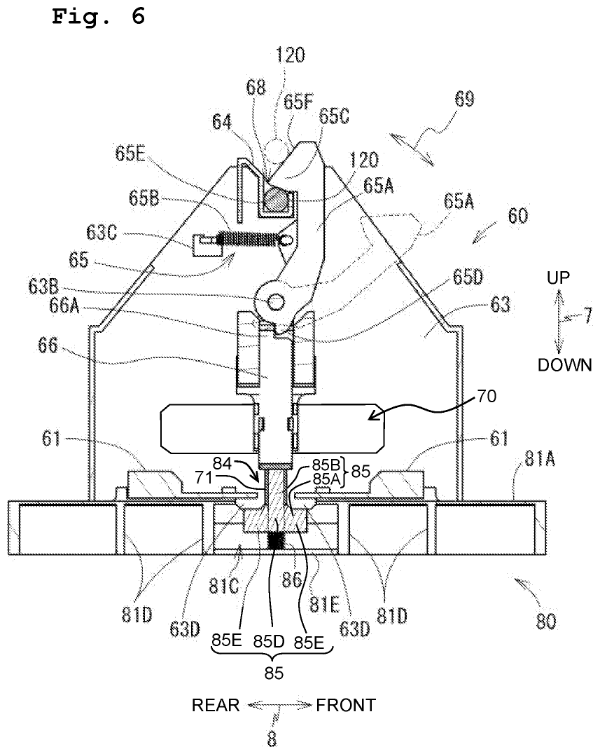

As depicted in FIG. 6, the bottom plate 81A has a shape of a box of which lower part is opened, and has a space 81C. Further, the bottom plate 81A is reinforced by a plurality of ribs 81D. Furthermore, there is provided a lower plate 81E which connects two ribs 81D, among the four ribs 81D, to each other. Moreover, an opening 84 is formed in the bottom plate 81A. A part of the opening 84 faces or is opposite to the lower plate 81E in the up-down direction 7, via the space 81C. As depicted in FIG. 3A, the opening 84A is formed at a right part of the bottom plate 81A, namely, the opening 84A is formed at a part, of the bottom plate 81A, which is on a side of the opening 32. As depicted in FIG. 3B, the opening 84 is formed at a central part in the front-rear direction 8 of the bottom plate 81A. As depicted in FIG. 6, a moving member 85 and a coil spring 86 are arranged in the space 81C.

As depicted in FIGS. 5 and 6, the moving member 85 is constructed of a bottom part 85A, and a projected part 85B which is projected upward from the bottom part 85A. The entirety of the bottom part 85A is arranged in the space 81C. A lower part of the projected part 85B is arranged in the space 81C, and an upper part of the projected part 85B is projected to the outside of the space 81C via the opening 84, namely projected upward from the bottom plate 81A. As depicted in FIG. 3A and FIG. 5, the projected part 85B is provided with an inclined surface 85C at a part, of the projected part 85B, which is on the right side and projected upward from the bottom plate 81A. The inclined surface 85C is a surface which inclined further upward as further toward the left side. In other words, the projected part 85B is provided with the inclined surface 85C on a side thereof facing the opening 32. The inclined surface 85C is a surface which inclined further toward the upper surface 30U as further away from the opening 32. In an install state in which the install part 60 is installed in the supporting mechanism 80, the projected part 85B engages with an opening 71 (to be described later on) of the install part 60.

As depicted in FIG. 6, the moving member 85 is provided with a projected part 85D on the left side of the moving member 85. Namely, the moving member 85 is provided with the projected part 85D at a side thereof facing the side plate 81B. The projected part 85D is projected leftward farther than flat parts 85E which are located on the both sides in the front-rear direction 8 of the projected part 85D. The projected part 85D straddles (spans) over the bottom part 85A and the projected part 85B, and extends in the up-down direction 7. The flat parts 85E are present only in the bottom part 85A. As described above, in the install state in which that install part 60 is installed in the supporting mechanism 80, the projected part 85B engages with the opening 71 (to be described later on) formed in the right side plate 63 of the install part 60. In this situation, the projected part 85D projects to the left side of the right side plate 63, via the opening 71. In this situation, the flat parts 85E make contact with a pair of projected parts 63D (to be described later on) of the install part 63 from the right side.

An upper end of the coil spring 86 is connected to the bottom part 85A, and a lower end of the coil spring 86 is connected to the lower plate 81E. With this, the moving member 85 is movable upward and downward (in the up-down direction 7). Note that since the bottom part 85A is greater than the opening 84, an upward movement of the moving member 85 is restricted at a position at which the bottom plate 85A makes contact with the bottom plate 81A from therebelow.

As depicted in FIG. 3B, the bottom plate 81A is provided with a pair of projected parts 87A and 87B which are projected upward. As depicted in FIG. 3B, the pair of projected parts 87A and 87B face each other in the front-rear direction 8. The projected part 87A is positioned in front of (at the front side of) the opening 84. The projected part 87B is positioned behind (at the rear side of) the opening 84. As depicted in FIG. 3A, the pair of projected parts 87A and 87B are positioned on the left side of the opening 84 in the right part of the bottom plate 81A. As depicted in FIG. 3B, the pair of projected parts 87A and 87B have through holes 88, respectively, each of which penetrate through one of the pair of projected parts 87A and 87B in the left-right direction 9.

As depicted in FIG. 4, the side plate 81B includes, at an upper end part thereof, a bent plate 81F which is bent to the left side. The bent plate 81F includes two ribs 89A and 89B which have a plate shape and which stand upward and extend in the front-rear direction 8. The rib 89A is positioned on the right side of the rib 89B. The two ribs 89A and 89B include through holes 90 which penetrate through the ribs 89A and 89B, respectively, in the left-right direction 9. The through hole 90 of the rib 89A and the through hole 90 of the rib 89B are positioned on a straight line extending in the left-right direction 9. Namely, the through hole 90A of the rib 89A and the through hole 90A of the rib 89B face each other in the left-right direction 9.

As depicted in FIG. 3B, the side plate 81B has a cutout 91 formed by performing cutting downward from an upper end of the side plate 81B. The cutout 91 is positioned on the right side of the rib 89A.

As depicted in FIG. 4, the side plate 81B includes, at a lower part thereof, a pair of through holes 92A and 92B and a through hole 93. The pair of through holes 92A and 92B face each other in the front-rear direction 8. The through hole 92A is positioned in front of the through holes 90. The through hole 92B is positioned behind the through holes 90. The pair of through holes 92A and 92B are long in a vertical direction (length thereof in the up-down direction 7 is longer than length thereof in the front-rear direction 8). The through hole 93 is positioned immediately below the through holes 90. The through hole 93 is positioned below (on the lower side) of the pair of through holes 92A and 92B. The through hole 93 is long in a lateral direction (length thereof in the front-rear direction 8 is longer than length thereof in the up-down direction 7).

The shaft 82 is supported by the bent plate 81F in a state that the shaft 82 penetrates through the through holes 90 of the ribs 89A and 89B. The shaft 82 is fixed to the bent plate 81F. The shaft 82 extends in the left-right direction 8. Namely, the axial direction of the shaft 82 is the left-right direction 9.

The gear 83 is supported by the shaft 82 so that the gear 83 is rotatable about an axis 82A of the shaft 82. The axis 82A is a line extending in the axial direction of the shaft 82 (left-right direction 9), and passing the center of a cross section of the shaft 82 (cross section cutting the shaft 82 by a plane orthogonal to the left-right direction 9).

The gear 83 is positioned on the right side of the rib 89A, and a lower part of the gear 83 enters into the cutout 91 (see FIG. 3B).

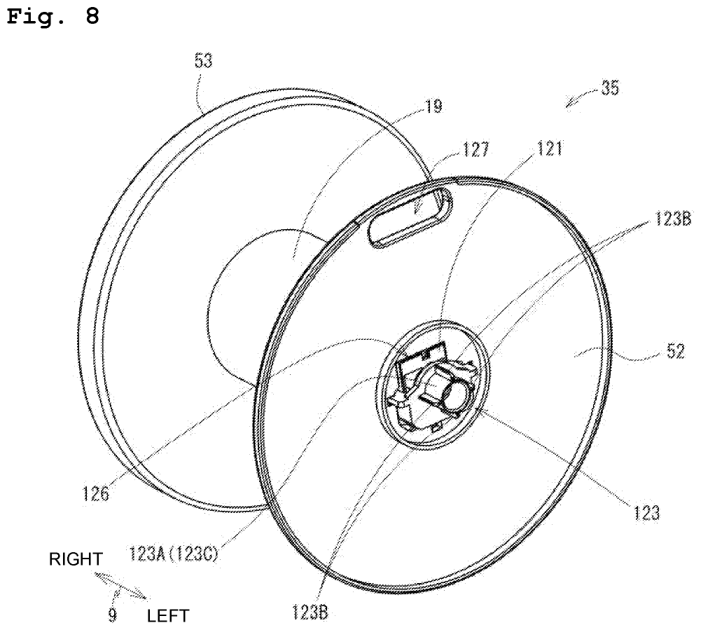

As depicted in FIGS. 3B and 4, the gear 83 includes a columnar body 94 (an example of an “engaged part”; an example of a “second engaging part”) in the inside in the radial direction of the gear 83. The columnar body 94 has a columnar shape, and is arranged such that the axial direction of the column is the left-right direction 9. The columnar body 94 is rotatable integrally with the gear 83 about the axis 82A. As depicted in FIG. 3B, the columnar body 94 has a circular-shaped through hole 96 penetrating through the columnar body 94 in the left-right direction 9, and a plurality of cutouts 95 (an example of the “engaged part”; an example of the “second engaging part”) formed to extend radially from an inner circumferential surface of the through hole 96 (outer edge of the through hole 96). The shaft 82 is inserted into a central part of the through hole 96. The diameter of the through hole 96 is greater than the diameter of the shaft 82. Thus, there is a gap between the shaft 82 inserted into the central part of the through hole 96 and the inner circumferential surface of the through hole 96. A main body 123A (see FIG. 8) of a joint part 123 (to be described later on) of the holder 35 is insertable into this gap.

The plurality of cutouts 95 are formed with a predetermined spacing distance therebetween in a circumferential direction 6 of the columnar body 94. As depicted in FIG. 3B, a width in the circumferential direction 6 of each of the plurality of cutouts 95 is the widest at a right end (an end in front of the sheet surface of FIG. 3B) of the columnar body 94, and becomes narrower toward the left side of the columnar body 94 (toward the far side of the sheet surface of FIG. 3B). Namely, a spacing distance in the circumferential direction 6 between a pair of surfaces 95A and 95B defining each of the plurality of cutouts 95 becomes narrower toward the left side (toward the far side of the sheet surface of FIG. 3B). In other words, the spacing distance in the circumferential surface 6 between the pair of surfaces 95A and 96B becomes narrower as being away farther from the opening 32 of the casing 30. The pair of surfaces 95A and 95B is an example of a “tapered part”.

As depicted in FIG. 3B, the gear 83 is subjected to driving transmission from the motor 104 via a driving transmitting mechanism (an example of a “driving transmitting part”) 105, and the gear 83 rotates integrally with the columnar body 94 about the axis 82A of the shaft 82. The motor 104 and the driving transmitting mechanism 105 are arranged in the internal space 30A of the casing 30. Although the driving transmitting mechanism 105 is constructed of publicly known gear, belt mechanism, etc., the driving transmitting mechanism 105 has at least one gear. Further, the at least one gear meshes with the gear 83.

<Install Part 60>

As depicted in FIGS. 4 and 5, the holder 35 is installable in the install part 60. Further, the install part 60 is installable in the supporting mechanism 80 in the sheet accommodating space 30C (see FIG. 2) inside the image recording apparatus 100. Further, the install part 60 is detachable (removable) from the supporting mechanism 80. The install part 60 detached from the supporting mechanism 80 is removable from the sheet accommodating space 30C to the outside of the image recording apparatus 100, via the opening 32. The installation (attachment) and detachment (removal) of the install part 60 with respect to the supporting mechanism 80 will be described later on.

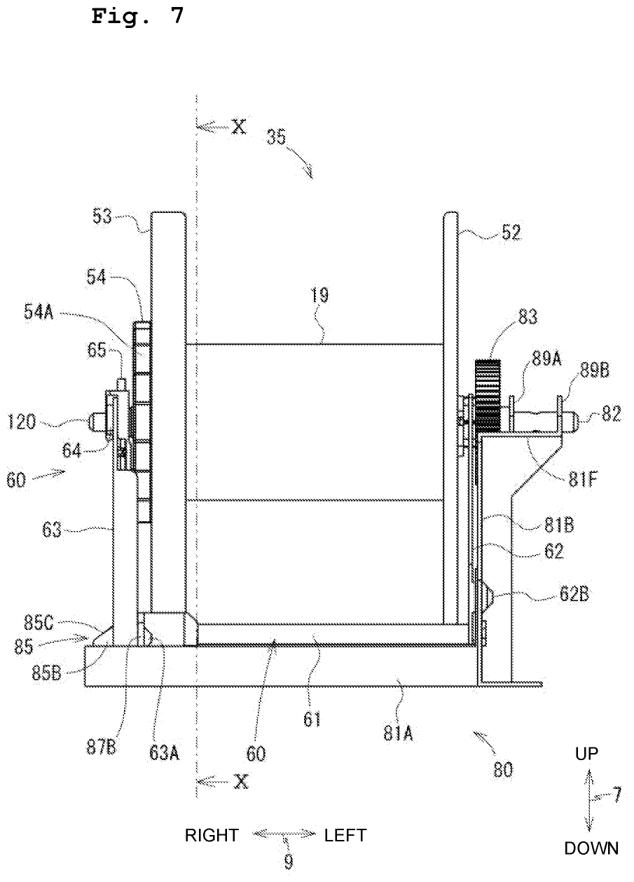

As depicted in FIGS. 5 and 7, the install part 60 includes a bottom plate 61, a left side plate 62, a right side plate 63 and a bearing (a bearing part) 64. Further, as depicted in FIG. 6, the install part 60 includes a locking mechanism 65 and an interlocking mechanism 66.

As depicted in FIG. 5, the bottom plate 61 is a plate spreading in the front-rear direction 8 and the left-right direction 9. The bottom plate 61 is supported by the bottom plate 81A of the frame 81 of the supporting mechanism 80 in an install state in which the install part 60 is installed in the supporting mechanism 80 (a state depicted in FIG. 5).

As depicted in FIG. 7, the left side plate 62 spreads in the front-rear direction 8 and the left-right direction 9, and is provided to stand upward from a left end part of the bottom plate 61.

As indicated in FIG. 4 with a broken line, the left side plate 62 has a cutout 67 which is formed to recessed downwards from an upper end thereof. The joint part 123 (see FIG. 8) of the holder 35 (to be described later on) is inserted into the cutout 67. In this state, a bottom plate 67A constructing the cutout 67 is capable of supporting the joint part 123.

As depicted in FIG. 4, the left side plate 62 has, at a lower part thereof, a pair of projected parts 62A and 62B which are projected leftward, and a projected part 62C which is projected leftward. The pair of projected parts 62A and 62B face each other in the front-rear direction 8. The projected part 62A is positioned in front of the cutout 67. The projected part 62B is positioned behind the cutout 67. The pair of projected parts 62A and 62B are long in the vertical direction (length thereof in the up-down direction 7 is longer than length thereof in the front-rear direction 8). The projected part 62C is positioned immediately below the cutout 67. The projected part 62C is positioned below (at a location on the lower side of) the pair of cutouts 62A and 62B. The projected part 62C is long in a lateral direction (length thereof in the front-rear direction 8 is longer than length thereof in the up-down direction 7).

In the install state in which the install part 60 is installed in the supporting mechanism 80, the pair of projected parts 62A and 62B are inserted into the pair of through holes 92A and 92B, respectively, which are provided on the side plate 81B of the supporting mechanism 80. Further, in the install state, the projected part 62C is inserted into the through hole 93 formed in the side plate 81B of the supporting mechanism 80.

As depicted in FIGS. 5 and 7, the right side plate 63 spreads in the front-rear direction 8 and the left-right direction 9, and formed to stand upright from the right end part of the bottom plate 61. An upper part of the right side plate 63 has a tapered shape of which length in the front-rear direction 8 becomes shorter further toward the upward direction. Note that the left side plate 62 as described above also has a tapered shape of which length in the front-rear direction 8 becomes shorter further toward the upward direction, similarly to the right side plate 63.

As depicted in FIGS. 5 and 6, the right side plate 63 has a cutout 68 which is formed to recessed downwards from an upper end thereof. The bearing 64 is fitted into and is fixed to the cutout 68. The bearing 64 is a member having a U-shaped part of which upper part is open in a side view along the left-right direction 9. The inner diameter of this U-shaped part is substantially same as the diameter of the shaft 120 of the holder 35. Accordingly, the shaft 120 of the holder 35 is fitted into the U-shaped part to thereby allow the bearing 64 to support the shaft 120 to be rotatable.

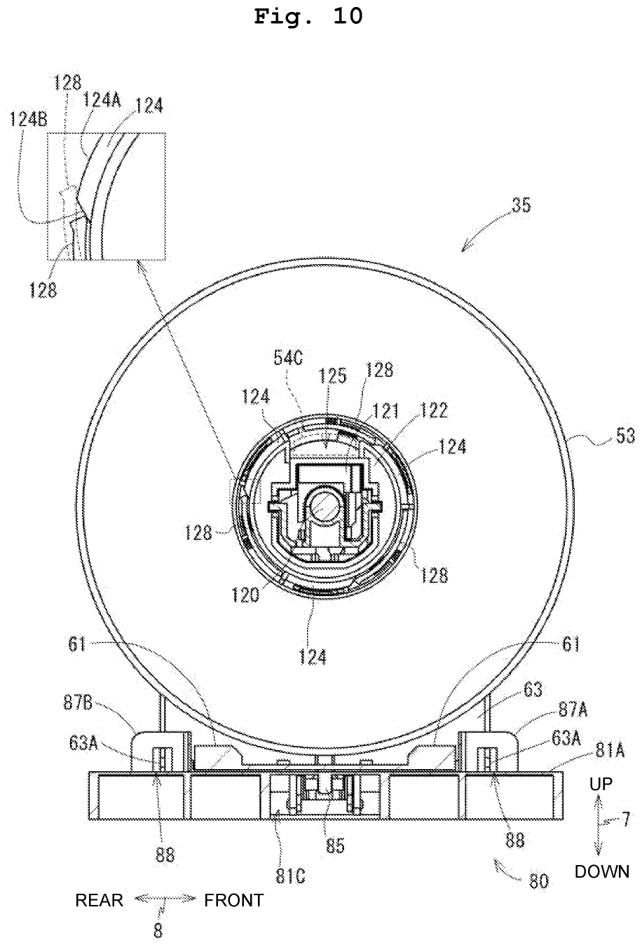

As depicted in FIGS. 4 and 10, the right side plate 63 has, at a front part and a rear part in a lower part thereof, a pair of projected parts 63A which are projected to the left side. The pair of projected parts 63A are provided with a spacing distance therebetween in the front-rear direction 8. Note that FIG. 4 only depicts a projected part 63A which is included in the pair of projected parts 63A and which is provided on the rear part of the lower part of the right side plate 63. As depicted in FIG. 10, the pair of projected parts 63A are inserted into the through holes 88, respectively, which are formed in the pair of projected parts 87A and 87B of the bottom plate 84A of the supporting mechanism 80.

As depicted in FIGS. 5 and 6, the opening 71 is formed in the install part 60. The opening 71 is formed to span from the right side plate 63 to the bottom plate 61. In the install state that the install part 61 is installed in the supporting mechanism 80, the projected part 85, of the moving member 85 of the supporting mechanism 80, which is projected upward engages with the opening 71. In this situation, the projected part 85D, of the moving member 85, which is projected leftward, is projected leftward of the right side plate 63 via the opening 71. Further, the right side plate 63 has a pair of projected parts 63D projected downward from a lower end of the right side plate 63. The pair of projected parts 63D are located on the both side, respectively, in the front-rear direction 8, of the opening 71 formed in the right side plate 63. In the install state in which the install part 60 is installed in the supporting mechanism 80, the pair of projected parts 63 are projected to the space 81C via the opening 84 formed in the bottom plate 81A of the supporting mechanism 84. In the space 81C, the flat parts 85E of the moving member 85 of the supporting mechanism 80 make contact with the pair of projected parts 63 from the right side (see FIG. 6).

As depicted in FIG. 5, the right side plate 63 has a through hole 70. The through hole 70 penetrates the right side plate 63 in the left-right direction 9. The through hole 70 is positioned at a location which is below the cutout 68 and which is above the pair of projected parts 87A and 87B.

As depicted in FIG. 6, the install part 60 includes the locking mechanism 65 and the interlocking mechanism 66 on the left side of the right side plate 63.

The locking mechanism 65 includes a rotating piece 65A and a coil spring 65B.

The rotating piece 65A is a flat plate-shaped and stick-shaped member. The rotating piece 65A is supported, by a projection 63B which is projected form the right side plate 63, so that the rotating piece 65A is rotatable in an orientation (direction) of an arrow 69. The rotating piece 65A is rotatable between a lock position indicated by a solid line in FIG. 6 and a non-lock position indicated by a broken line in FIG. 6.

The rocking piece 65A includes a projection 65C at a rotation forward end part thereof, and a projection 65D provided on a rotation base end part thereof. The projection 65C is located at a position immediately above the U-shaped part of the bearing 64 in a case that the rotating piece 65A is at the lock position; and the projection 65C is located at a position shifted from the position immediately above the U-shaped part of the bearing 64 in a case that the rotating piece 65A is at the non-lock position. The projection 65C has inclined surfaces 65E and 65F. The inclined surface 65E is a surface located at a position above the U-shaped part of the bearing 64 and facing the U-shaped part in the up-down direction 7 in a state that the rotating piece 65A is at the lock position. In the state that the rotating piece 65A is at the lock position, the inclined surface 65E is a surface inclined upward further toward the rear side. The inclined surface 65F is connected to the inclined surface 65E. In the state that the rotating piece 65A is at the lock position, the inclined surface 65F is located at a position above the inclined surface 65E, and is a surface inclined upward further toward the front side.

An end of the coil spring 65B is connected to the rotating piece 65A. The other end of the coil spring 65B is connected to the projected part 63C provided on the right side plate 63. The rotating piece 65A is biased toward the lock position by the coil spring 65B.

The interlocking mechanism 66 is constructed of a plate-shaped member which is long in the up-down direction 7. The interlocking mechanism 66 is supported by the right side plate 63 to be movable upward and downward (in the up-down direction 7). A lower end of the interlocking mechanism 66 makes contact with the projection 85B of the moving member 85 to thereby allow the interlocking mechanism 66 to be supported by the projection 85B. With this, the interlocking member 66 is moved upward and downward integrally with the moving member 85. Normally, the interlocking mechanism 66 is located at an upper position as depicted in FIG. 6. In a case that the moving member 85 is moved downward from the position depicted in FIG. 6, the interlocking mechanism 66 is moved to a position lower than the position indicated in FIG. 6 by the self-weight thereof.

The interlocking mechanism 66 includes a projected part 66A which is projected upward from a rear part of the upper end thereof. In a case that the interlocking mechanism 66 is located at the upper position and that the rotating piece 65A is located at the lock position, the projection 65D of the rotating piece 65A makes contact with the projected part 66A from a position in front thereof. With this, a rotation of the rotating piece 65A from the lock position toward the non-lock position is restricted or regulated.

<Holder 35>

The holder 35 as depicted in FIGS. 7 to 9 supports the roll body 37. As depicted in FIGS. 4 and 5, the holder 35 is installable in the install part 60. The holder 35 installed in the install part 60 is supported by the install part 60 to be rotatable. Further, the holder 35 is detachable (removable) from the install part 60. The installation/detachment of the holder 35 with respect to the install part 60 will be described later on.

Note that in the following explanation of the construction of the holder 35, the up-down direction 7, the front-rear direction 8 and the left-right direction 9 are defined on such an assumption that the holder 35 is in a state of being installed in the install part 60 and that the install part 60 is in a state of being supported by the supporting mechanism 80 (the state depicted in FIG. 4).

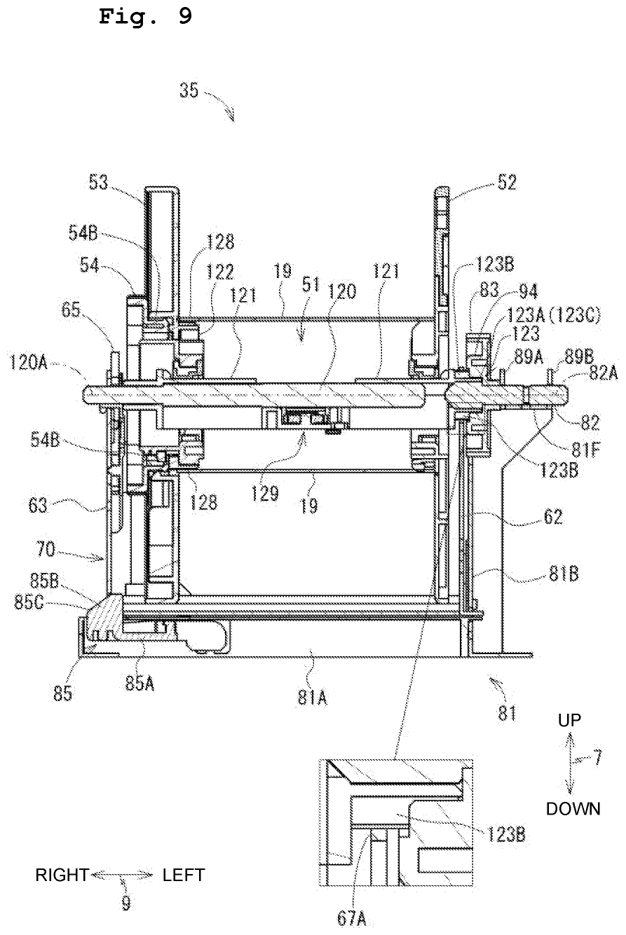

As depicted in FIGS. 7 to 9, the holder 35 includes a shaft mechanism 51 (see FIG. 9; an example of a “second shaft”), a left flange 52, a right flange 53 (an example of a “flange” or a “flange part”), and a grasping member 54.

As depicted in FIG. 9, the shaft mechanism 51 includes a shaft 120, a first externally fitting part 121 and a second externally fitting part 122.

The shaft 120 is a stick-shaped member. The shaft 120 extends in the left-right direction 9. In this state, the shaft 120 is coaxial with the shaft 82 of the supporting mechanism 80. Namely, an axis 120A (indicated by a chain line in FIG. 9) of the shaft 120 is on a same straight line with the axis 82A (indicated by a two-dot chain line in FIG. 9) of the shaft 82. The axis 120A is a line extending in the axial direction of the shaft 120, and passing the center of a cross section (surface orthogonal to the axial direction) of the shaft 120.

The first externally fitting part 121 is a member having a substantially quadrangular prism shape and having an internal space, and is externally fitted to the shaft 120. The first externally fitting part 121 is fixed to the shaft 120.

A right end of the shaft 120 is projected rightward from the first externally fitting part 121. The right end part (an example of the “other end of the second shaft”) of the shaft 120 is fitted into the bearing 64 of the install part 60 in a case that the holder 35 is installed in the install part 60 (see FIG. 5). With this, the bearing 64 supports the right end of the shaft 120. Further, the right end of the shaft 120 is removed (pulled out) from the bearing 64 of the install part 60 in a case that the holder 35 is detached from the install part 60. Namely, the bearing 64 supports the right end of the shaft 120 to be detachable and attachable (detachably attachable).

On the other hand, as depicted in FIG. 9, a left end of the shaft 120 is positioned in the internal space of the first externally fitting part 121. Namely, the left end of the shaft 120 is not projected leftward from the first externally fitting part 121.

As depicted in FIGS. 8 and 9, the joint part 123 (an example of a “joint”) is projected leftward from a left end of the first externally fitting part 121. Namely, the joint part 123 is provided on the left end of the shaft mechanism 51 (an example of a “one end of the second shaft”). The joint part 123 includes a main body 123A having a circular cylindrical shape, and a rib 123B (an example of an “engaging part”; and example of a “first engaging part”) which is projected radially from a circumferential surface 123C of the main body 123A. Note that the main body 123A is not limited to having the circular cylindrical shape; it is sufficient that the main body 123A has a cylindrical shape.

An internal space of the main body 123A is communicated with the internal space of the first externally fitting part 121. The main body 123A is coaxial with the shaft 120. Namely, the axis of the main body 123A is the axis 120A of the shaft 120. The axis of the main body 123A is a line extending in the left-right direction 9 (a projecting direction of the main body 123A) and passing the center of a cross section (surface orthogonal to the projecting direction) of the main body 123A.

The rib 123B is provided as four ribs 123B with a spacing distance therebetween along the circumferential direction of the external circumferential surface (circumferential surface 123C) of the main body 123A. Each of the ribs 123B extends in the left-right direction on the circumferential surface 123C. In a state that the holder 35 is installed in the install part 60, each of the ribs 123B is engageable with one of the cutouts 95 (see FIG. 3) of the columnar body 94 of the supporting mechanism 80. Note that the number of the rib 123B is not limited to being 4 (four).

As depicted in FIGS. 9 and 10, the second externally fitting part 122 is externally fitted to a right end part of the first externally fitting part 121. The second externally fitting part 122 is slidable in the left-right direction 9 with respect to the first externally fitting part 121. The second externally fitting part 122 has a substantially disc shape.

The second externally fitting part 122 has, in an outer circumferential surface thereof, three projected parts 124 and one cutout 125.

The three projected parts 124 are provided with a spacing distance therebetween along the circumferential direction of the outer circumferential surface of the second externally fitting part 122. The spacing distance is substantially same as a length along the circumferential direction of a leaf spring part 128 (to be described later on) of the right flange 53. As depicted in an enlarged view of FIG. 10, each of the three projected parts 124 has a circumferential surface 124A along the circumferential direction, and an inclined surface 124B which is continuous from the circumferential surface 124A and which is inclined, with respect to the circumferential direction, to be directed toward the radial direction of the second externally fitting part 122 (toward a direction toward the shaft 120). The circumferential surface 124A and the inclined surface 124B construct a part of the outer circumferential surface of the second externally fitting part 122. The inclined surface 124B is an example of a “cam surface”.

The cutout 125 is formed between two projected parts 124 among the three projected parts 124. A second projected part 54C (to be described later on) of the grasping member 54 enters into the cutout 125.

As depicted in FIG. 8, the left flange 52 is a disc-shaped member having an opening in a central part thereof. The left flange 52 is externally fitted to a left end part of the first externally fitting part 121. Specifically, a through hole 126 having a substantially rectangular shape corresponding to a cross-sectional shape of the first externally fitting part 121 is formed in the central part of the left flange 52; and the left end part of the first externally fitting part 121 is inserted into the through hole 126. With this, the left flange 52 is rotatable integrally with the first externally fitting part 121. Further, the left flange 52 is slidable in the left-right direction 9 with respect to the first externally fitting part 121.

The left flange 52 has a through hole 127 (see FIG. 4) at an end part thereof in the radial direction. The through hole 127 penetrates through the left flange 52 in the left-right direction 9. Note that in the present embodiment, although the through hole 127 is provided only on the left flange 52, the through hole 127 may be provided only on the right flange 53, or may be provided on both of the left flange 52 and the right flange 53.

As depicted in FIGS. 5 and 10, the right flange 53 is a disc-shaped member having an opening in a central part thereof. The first externally fitting part 121 of the shaft mechanism 51 and the shaft 120 are inserted into the opening provided on the central part of the right flange 53. Further, a first projected part 54B of a grasping member 54 (to be described later on) is also insertable into this opening (see FIG. 9). The right flange 53 is slidable in the left-right direction 9 with respect to the shaft mechanism 51; the right flange 53 is detachably attachable (attachable/detachable) with respect to the shaft mechanism 51 by sliding rightward with respect to the shaft mechanism 51. As depicted in FIG. 10, a leaf spring part 128 (an example of a “moving part”) which will be explained below is externally fitted to the second externally fitting part 121 to thereby allow the right flange 53 to be installed in the shaft mechanism 51. The right flange 53 externally fitted to the second externally fitting part 122 is rotatable about the shaft mechanism 51.

The right flange 53 has three piece of the leaf spring part 128. As depicted in FIG. 9, each of the three leaf spring parts 128 is projected leftward from the left surface of the right flange 53. The three leaf spring parts 128 extend along the circumferential direction of the right flange 53, and are provided with a spacing distance therebetween along the circumferential direction. This spacing distance is substantially same as the length along the circumferential direction of each of the three projected parts 124 of the second externally fitting part 122 as described above.

Each of the three leaf spring parts 128 is connected to the main body part (disc-shaped part) of the right flange 53, only at a part, of each of the three leaf spring parts 128, in the circumferential direction of the right flange 53. This part is one end part of the both end parts of the leaf spring part 128 in the circumferential direction, and the one end part does nor face the inclined surface 124B of the projected parts 124 of the second externally fitting part 122. Each of the three leaf spring parts 128 is flexible in the radial direction of the right flange 53, with this part as the center of the flexion.

Note that the left flange 52 and the right flange 53 are connected to each other by a rack pinion mechanism 129 (see FIG. 9) in a state that the left flange 52 and the right flange 53 are installed in the shaft mechanism 51. With this, accompanying with a sliding of one of the left flange 52 and the right flange 53 to one of the right side and left side with respect to the shaft mechanism 51, the other of the left flange 52 and the right flange 53 is slid to the other of the right side and left side with respect to the shaft mechanism 51. With this, it is possible to easily adjust the distance in the left-right direction 9 between the left flange 52 and the right flange 53. As a result, the holder 53 is capable of accommodating a plurality of kinds of the roll body 37 having sheets S of which width (length in the left-right direction 9) are different from each other, respectively, wound therein.

As depicted in FIG. 5, the grasping member 54 is a disc-shaped member having an opening in the central part thereof. The first externally fitting part 121 of the shaft mechanism 51 and the shaft 120 are inserted into this opening. Note, however, that concavities and convexities are formed in an outer circumferential surface 54A of the grasping member 54. The grasping member 54 includes a first projected part 54B (see FIG. 9) and a second projected part 54C (see FIG. 10). The first projected part 54B is projected leftward from a central part in the left surface (a part surrounding the opening in the central part of the left surface) of the grasping member 54. The first projected part 54B is insertable into an opening formed in a central part of the right flange 53. The second projected part 54C depicted in FIG. 10 is projected leftward from the left surface of the first projected part 54B. As depicted in FIG. 10, the second projected part 54C is insertable into the cutout 125 of the second externally fitting part 122, and is engageable with the cutout 125.

<Attachment and Detachment of Roll Body 37 with Respect to Holder 35>

In the following, a procedure of attaching/detaching the roll body 37 with respect to the holder 35 will be explained.

At first, the right flange 53 of the holder 35 as depicted in FIG. 8 is detached from the shaft mechanism 51. Next, the roll body 37 is attached to the shaft mechanism 51 from the right side of the shaft mechanism 51. In other words, the shaft mechanism 51 is inserted into the roll body 37 with the right end of the shaft mechanism 51 as the leading edge. In this situation, the shaft mechanism 51 is positioned inside the core tube 19 of the roll body 37 (see FIG. 9).

Next, as depicted in FIG. 9, the right flange 53 is inserted to the shaft mechanism 51 from the right side, and is installed in the shaft mechanism 51. Specifically, the leaf spring parts 128 provided on the left surface of the right flange 53 are externally fitted to the second externally fitting part 122. Here, in a state that the right flange 53 is installed in the shaft mechanism 51, the leaf spring parts 128 are at the same positions, respectively, with the three projected parts 124 of the second externally fitting parts 122, in the radial direction of the shaft mechanism 51. Therefore, only in a case that each of the leaf spring parts 128 is located between two projected parts 124, among the three projected parts 124, which are adjacent to each other, the right flange 53 is installable in the shaft mechanism 51. Accordingly, the right flange 53 is inserted into the shaft mechanism 51 while being rotated. Further, at a position at which each of the leaf spring parts 128 is located between the two adjacent projected parts 124, among the three projected parts 124, the right flange 53 is installed in the shaft mechanism 51. Note that the leaf spring parts 128 are positioned inside the core tube 19 of the roll body 37. Namely, the leaf spring parts 128 are positioned between the second externally fitting part 122 and the inner surface of the core tube 19. The leaf spring parts 128 make contact with an inner wall surface of the core tube 19 of the roll body 37.

Next, accompanying with the leftward sliding of the right flange 53, the left flange 52 is slid rightward. With this, the right end and the left end of the roll body 37 make contact with the right flange 53 and the left flange 52, respectively. Namely, the roll body 37 is positioned in the left-right direction 9, with the center in the left-right direction 9 as the reference, by the right flange 53 and the left flange 52, depending on the length in the width direction (left-right direction 9) of the roll body 37. Note that the second externally fitting part 122 slides integrally with the right flange 53, following the sliding in the left-right direction 9 of the right flange 53.

Next, as depicted in FIG. 5, the grasping member 54 is installed in the right flange 53 from the right side of the right flange 53. Specifically, the first projected part 54B of the grasping member 54 is inserted into the opening formed in the center of the right flange 53. Further, the grasping member 54 is inserted into the right flange 53 while being rotated so that the second projected part 54C of the grasping member 54 is at a position at which the second projected part 54C is inserted into the cutout 125 of the second externally fitting part 122 (see FIG. 10).

Next, the user rotates the grasping member 54, with respect to the flange 53, in an orientation of an arrow 130 depicted in FIG. 5 while holding (grasping) the outer circumferential surface 54A (see FIG. 5) of the grasping member 54. By doing so, the second projected part 54C of the grasping member 54 as depicted in FIG. 10 rotates counterclockwise in FIG. 10, and pushes or presses the projected parts 124 of the second externally fitting part 122. With this, the second externally fitting part 122 also rotates counterclockwise in FIG. 10. Namely, the second externally fitting part 122 rotates relative to the right flange 53. Then, the inclined surface 124B of each of the projected parts 124B makes contact with and pushes (presses) one of the leaf spring parts 128. This provides a state that each of the leaf spring parts 128 is guided by the inclined surface 124B and rides on the circumferential surface 124A. Namely, the state of each of the leaf spring parts 128 is changed from a state indicated by a solid line in the enlarge view of FIG. 10 to a state indicated by a broken line in the enlarge view of FIG. 10. Namely, a part of each of the leaf spring parts 128 is moved to the outside in the radial direction of the shaft mechanism 51 and presses the core tube 19 of the roll body 37 toward the outside in the radial direction. As a result, the position of the roll body 37 installed in the holder 35 is stabilized.

The detachment (removal) of the roll body 37 from the holder 35 is executed by a procedure which is substantially reverse to the procedure of installing the roll body 37 in the holder 35. Namely, at first, the grasping member 54 is rotated in an orientation reverse to that of the arrow 130 depicted in FIG. 5. With this, the state of each of the leaf spring parts 128 is changed from the state indicated by the broken line in the enlarge view of FIG. 10 to the state indicated by the solid line in the enlarge view of FIG. 10. Next, the grasping member 54 is detached (removed) from the right flange 53, and the right flange 53 is detached from the shaft mechanism 51. Lastly, the roll body 37 is detached from the shaft mechanism 51.

<Attachment (Installation)/Detachment of Holder 35 with Respect to Install Part 60>

In the following, a procedure of installing the holder 35 with respect to the install part 60 will be explained. Note that installation of the holder 35 in the install part 60 is executed at the outside of the image recording apparatus 100. Namely, before installing the holder 35 in the install part 60, the install part 60 is detached from the supporting mechanism 80, and is slid leftward to thereby be pulled out to the outside of the image recording apparatus 100. Note that a procedure of detaching the install part 60 from the supporting mechanism 80 will be described later on.

The user inserts his or her finger into the through hole 127 of the holder 35 to thereby grasp the holder 35. Further, the grasped holder 35 is installed in the install part 60 from thereabove. Since the holder 35 is provided with the through hole 127, it is thereby possible to easily lift the holder 35 up and to easily install the holder 35 in the install part 60.

First, an explanation will be given about the state of a right side end of the holder 35 during the installation. In a case that the holder 35 is installed in the install part 60, the right end of the shaft 120 makes contact with the inclined surface 65F of the rotating piece 65A, which is located at the lock position, from thereabove as indicated in the broken line in FIG. 6, and pushes or presses the inclined surface 65F downward. As the right end of the shaft 120 moves downward, the rotating piece 65A rotates, against the biasing force of the coil spring 65B, from the lock position indicated by the solid line in FIG. 6 toward the non-lock position indicated by the broken line in FIG. 6. Note that in this situation, since the interlocking mechanism 66 is moved to the lower position by the self-weight thereof, the rotation of the rotating piece 65A is not regulated by the projected part 66A of the interlocking mechanism 66. In a case that the right end of the shaft 120 passes the rotating piece 65A and is positioned below the rotating piece 65A, the right end of the shaft 120 is fitted into the U-shaped part of the bearing 64 attached to the right side plate 63. Note that in a case that the right end of the shaft 120 passes the rotating piece 65A, the rotating piece 65A rotates from the non-lock position toward the lock position due to the biasing force of the coil spring 65B. With this, a location above the right end of the shaft 120 is in a state of being blocked by the rotating piece 65A (see FIG. 6).

Next, an explanation will be given about the state of a left side end of the holder 35 during the installation. In the case of installing the holder 35 in the install part 60, the joint part 123 (see FIG. 8) of the holder 35 is inserted into the cutout 67 (see FIG. 4) formed in the left side plate 62 of the install part 60. The joint part 123 makes contact with the bottom surface 67A (an example of a “temporarily supporting part”; see FIG. 4), which constructs the cutout 67, from a location above the bottom surface 67A. With this, the bottom surface 67A supports the joint part 123 from therebelow. Further, with this, in a process that the install part 60 is installed in the supporting mechanism 80, the shaft 82 of the supporting mechanism 80 is positioned at a position at which the shaft 80 is insertable into the internal space of the joint part 123. Note that, as will be described later on, in a case that the install part 60 supporting the holder 35 is further installed in the supporting mechanism 80, the bottom surface 67A does not support the joint part 123. Namely, at this point of time, the bottom surface 67A supports the joint part 123 temporarily.

As described above, both the left and right side ends of the holder 35 are supported by the right side plate 63 and the left side plate 62, respectively, of the install part 60, the holder 35 is installed in the install part 60.

The detachment (removal) of the holder 35 from the install part 60 is executed in a procedure as described below. Namely, the user inserts his or her finger into the through hole 127 to thereby grasp the holder 35. Further, the grasped holder 35 is lifted upward. With this, the right end of the shaft 120 is away (separated away) from the bearing 64, and the joint part 123 is separated away from the bottom surface 67A of the cutout 67, and the holder 35 is removed or detached from the install part 60.

Note that in a case that the right end of the shaft 120 is being separated away from the bearing 64, the right end of the shaft 120 makes contact with the inclined surface 65E of the rotating piece 65A, which is located at the lock position, from therebelow as indicated by the solid line in FIG. 6 and pushes the inclined surface 65E of the rotating piece 65A upward. As the right end of the shaft 120 moves upward, the rotating piece 65A rotates, against the biasing force of the coil spring 65B, from the lock position indicated by the solid line in FIG. 6 toward the non-lock position indicated by the broken line in FIG. 6. Note that similarly to the case of installing, since the interlocking mechanism 66 is moved to the lower position by the self-weight thereof, the rotation of the rotating piece 65F is not regulated by the projected part 66A of the interlocking mechanism 66. In a case that the right end of the shaft 120 passes the rotating piece 65A, is positioned above the rotating piece 65A and moves out of the bearing 64, the rotating piece 65A rotates from the non-lock position to the lock position due to the biasing force of the coil spring 65B.

<Attachment and Detachment of Install Part 60 with Respect to Supporting Mechanism 80>

A procedure of installing the install part 60, in which the holder 35 is installed, in the supporting mechanism 80 will be explained in the following. Namely, a procedure of installing the install part 60 in the inside of the casing 30 will be explained.

The install part 60 is slid from the right side to the left side of the casing 30, and thus is accommodated in the sheet accommodating space 30C (see FIG. 2) via the opening 32 (see FIG. 1). In this situation, the install part 60 is inserted into the casing 30 such that the left side plate 62 becomes the leading end of the insertion, and that the right side plate 63 becomes the rear end of the insertion. In this situation, the user inserts his or her finger into the through hole 70 (see FIG. 5) of the install part 60 to thereby grasp the install part 60. Since the install part 60 has the through hole 70, it is possible for the user to easily grasp the install part 60, and to easily slide the install part 60.

The install part 60 is slid leftward on the bottom plate 81A of the supporting mechanism 80 such that the bottom plate 61 passes between the pair of projected parts 87A and 87B (see FIG. 3B) which are provided on the bottom plate 81A. In this situation, the install part 60 is positioned in the up-down direction 7 by being supported by the bottom plate 81A. Further, in this situation, the front end of the bottom plate 61 of the install part 60 makes contact with a rear surface 79 (see FIG. 3B) of the projected part 87A, and the rear end of the bottom plate 61 of the install part 60 makes contact with a front surface 78 (see FIG. 3B) of the projected part 87B, thereby allowing the install part 60 to be slidable while being positioned in the front-rear direction 8.

As depicted in FIG. 4, the left side plate 62 of the install part 60 makes contact with the side plate 81B of the supporting mechanism 80 from the right side, thereby stopping the leftward slide of the install part 60. Namely, the install part 60 is installed in the supporting mechanism 80.

In this situation, the pair of projected parts 62A and 62B provided on the left side plate 62 of the install part 60 are inserted into and engaged with the pair of through holes 92A and 92B, respectively, provided on the side plate 81B of the supporting mechanism 80. Further, the pair of projected parts 63A provided on the right side plate 63 of the install part 60 are inserted into and engaged with the through holes 88 formed in the pair of projected parts 87A and 87B, respectively, of the supporting mechanism 80. Furthermore, in this situation, the projected part 62C of the install part 60 is inserted into and engaged with the through hole 93 formed in the side plate 81B of the supporting mechanism 80. With this, the install part 60 is positioned, with respect to the supporting mechanism 80, in the front-rear direction 8 and the up-down direction 7.

Moreover, in the case that the install part 60 is slid leftward, the leading end (forward end) of the install part 60 (left side plate 62) makes contact with and presses the inclined surface 85C (see FIG. 5) of the moving member 85 of the moving mechanism 80. With this, the moving member 85 is moved downward against the biasing force of the coil spring 86 (see FIG. 6) and is in a state of being accommodated in the space 81C. Further, the bottom plate 61 of the install part 60 is slid leftward while passing on the moving member 85.

The install part 60 is slid further leftward, the opening 70 formed in the rear end of the install part 60 arrives at the moving member 85. With this, since there is not the thing (the bottom plate 61) which presses or pushes the moving member 85 from thereabove, the moving member 85 moved upward, via the opening 71, due to the biasing force of the coil spring 86 and is projected upward from the bottom plate 81A. Namely, the moving member 85 of the supporting mechanism 80 engages with the opening 71 of the install part 60. With this, the installation of the install part 60 in the supporting mechanism 80 is completed. In this situation, a part of the moving member 85 (the projected part 85D) is projected, via the opening 71, leftward with respect to (to the left side of) the right side plate 63. With this, as depicted in FIG. 6, the interlocking mechanism 66 which is provided on the left side of the right side plate 63 is moved upward by being pushed by the moving member 85. By the upward movement of the interlocking mechanism 66, the projected part 66A of the interlocking mechanism 66 is moved to a height adjacent to a location behind (on the rear side of) the projection 65D of the rotating piece 65A. With this, the rotation of the rotating piece 65A from the lock position toward the non-lock position is consequently regulated by the contact made by the projection 65D with the projected part 66A.

Further, in the case that the install part 60 is installed in the supporting mechanism 80, the bottom part 85A (the flat parts 85E) of the moving member 85 which is moved upward makes contact, from the right side, with a pair of projected parts 63D which are projected into the inside of the space 81C from the lower end of the right side plate 63 of the install part 60. Furthermore, in the case that the install part 60 is installed in the supporting mechanism 80, the side plate 81B of the bottom plate 81A of the supporting mechanism 80 makes contact, from the left side, with the left side plate 62 of the install part 60. With this, in the case that the install part 60 is installed in the supporting mechanism 80, the install part 60 is positioned in the left-right direction 9 by the side plate 81B and the moving member 85.

In the install state that the install part 60 is installed in the supporting mechanism 80, the rightward slide of the install part 60 is regulated by the moving member 85 (the flat parts 85E) which makes contact, from the right side, with the pair of projected parts 63D of the right side plate 63, as described above. Namely, the rightward slide of the install part 60 is locked by the moving member 85 (an example of a “second look state”). The moving member 85 and the coil spring 86 biasing the moving member 85 are capable of locking the install part 60 in the state that the install part 60 is installed in the supporting mechanism 80. The moving member 85 and the coil spring 86 are examples of a “second locking part”.

In the state that the install part 60 is installed in the supporting mechanism 80, the detachment (removal) of the right end of the shaft 120 of the holder 35 from the bearing 64 is regulated by the rotating piece 65A, as will be described in detail in the following. As described above, in a case that the right end of the shaft 120 is separated away from the bearing 64, the right end of the shaft 120 makes contact, from the lower position, with the inclined surface 65E of the rotating piece 65A which is located at the lock position as indicated by the solid line in FIG. 6, and pushes or presses the inclined surface 65E upward. In this case, normally, the rotating piece 65A rotates from the lock position as indicated by the solid line in FIG. 6 toward the non-lock position indicated by the broken line in FIG. 6. However, in the state that the install part 60 is installed in the supporting mechanism 80, the rotating of the rotating piece 65A from the lock position toward the non-lock position is regulated since the projection 65D makes contact with the projected part 66A of the interlocking mechanism 66. Therefore, the rotating piece 65A remains at the lock position, and it is not possible to remove the right end of the shaft 120 from the bearing 64. Namely, the locking mechanism 65 is capable of locking the shaft 120 in a state that the right end of the shaft 120 is installed in the bearing 64 (an example of a “first look state”). Thus, the locking mechanism 65 is an example of a “first locking part”.

As described above, the interlocking mechanism 66 moves upward accompanying with the upward movement of the moving member 85 (operation in which the moving member 85 locks the install part 60 in a state that the install part 60 is installed in the supporting mechanism 80). With this, the interlocking mechanism 66 executes regulation of the rotation of the rotating piece 65A from the lock position toward the non-lock position (operation in which the rocking mechanism 65 locks the shaft 120 in a state that the right end of the shaft 120 is installed in the bearing 64). In other words, the interlocking mechanism 66 interlocks the rotating piece (the first locking part) 65A with the moving member (the second locking part) 85, namely, the interlocking mechanism 66 maintain the rotating piece (the first locking part) 65A in the lock position (the first lock state) in conjunction with the upward movement of the moving member 85 (a locking operation of the second locking part).

Further, as described above, the install part 60 is installed in the supporting mechanism 80 while being positioned in the up-down direction 7 and the front-rear direction 8. During the process of the installation, the joint part 123 of the holder 35 is positioned at the position at which the joint part 123 is substantially coaxial with the shaft 82 of the supporting mechanism 80.

Furthermore, in the process in which the install part 60 is installed in the supporting mechanism 80, the joint part 123 is inserted, from the right side, into the through hole 96 (see FIG. 3) of the columnar body 94 along the axis 82A of the shaft 82, as depicted in FIG. 9. On the other hand, the shaft 82 of the supporting mechanism 80 is inserted, from the left side, into the internal space of the main body 123A of the joint part 123 along the axis 82A of the shat 80. Namely, the shaft 82 having the diameter smaller than the diameter of the through hole 96 is inserted into the central part of the through hole 96, and a gap is defined between the shaft 82 and the inner circumferential surface of the through hole 96. The main body 123A (see FIG. 8) of the joint part 123 is inserted into this gap. In this situation, at the same time, the shaft 82 is inserted into the inner space of the main body 123A.

Moreover, in a case that the joint part 123 of the install part 60 is inserted into the through hole 96 of the columnar body 94, the ribs 123B of the joint part 123 are inserted into the cutouts 95 (see FIG. 3B), respectively, of the columnar body 94. In this situation, each of the ribs 123B is fitted in one of the cutouts 95 by making contact with and being guided by the pair of surfaces 95A and 95B which construct one of the cutouts 95. Namely, even in such a case that there is a deviation, to some extent, in the positions of the joint part 123 and the columnar body 94 in the circumferential direction, each of the ribs 123B makes contact with the pair of surfaces 95A and 95B of one of the cutouts 95 and is guided by the pair of surfaces 95A and 95B of one of the cutouts 95 in the circumferential direction, thereby correcting such a deviation in the positions.

Further, even in such a case that there is a deviation, to some extent, in the positions of the joint part 123 and the columnar body 94 not only in the circumferential direction but also in the up-down direction 7, each of the ribs 123B makes contact with and is guided by the pair of surfaces 95A and 95B of one of the cutouts 95, thereby correcting such a deviation in the positions. A detailed explanation will be given in the following.

As described above, in the state that the holder 35 is installed in the install part 60, the joint part 123 is contacted, from therebelow, by the bottom surface 67A which constructs the cutout 67 of the install part 60 and is supported by the bottom surface 67A. In this state, the joint part 123 is shifted downward slightly from the columnar body 94. As describe above, however, in a case that the joint part 123 is inserted into the through hole 96 of the columnar body 94, each of the ribs 123B is guided by one of the pair of surfaces 95A and 95B of one of the cutouts 95, and thus the joint part 123 is lifted upward by the columnar body 94. Further, in a case that the install part 60 is allowed to be in the install state that the install part 60 is installed in the supporting part 80, the ribs 123B are allowed to be in a state that the ribs 123B are completely fitted in the cutouts 95, respectively. In this situation, as depicted in the enlarged view of FIG. 9, the joint part 123 is located above the bottom surface 67A, and is separate away from the bottom surface 67A. Furthermore, in this situation, the joint part 123 is installed in the shaft 82, which in turn allows the shaft 82 to be completely coaxial with the shaft mechanism 51 (specifically, the shaft 120 of the shaft mechanism 51). Namely, the install state, in which the install part 60 is installed in the supporting mechanism 80, is a state that the joint part 123 of the shaft mechanism 51 is installed in the shaft 82. In other words, the install state is an attached state in which the shaft mechanism (the second shaft) 51 is attached to the shaft (the first shaft) 82.

In the install state that the install part 60 is installed in the supporting mechanism 80, in other words that each of the ribs 123 is completely fitted into one of the cutouts 95 (a state that the joint part 123 is linked with the columnar body 94 of the gear 83), the rotation of the gear 83 which is subjected to the driving transmittance from the motor 104 depicted in FIG. 3 via the driving transmitting mechanism 105 depicted in FIG. 3 is transmitted to the shaft mechanism 51 of the holder 35 via the columnar body 94 and the ribs 123B. With this, the holder 35 is rotated, and the sheet S of the roll body 37 is fed out. Namely, the ribs 123B are a part of a “rotation transmitting part”. Further, the ribs 123B (an example of the “first engaging part”), the columnar body 94 (more specifically, the cutouts 95; an example of the “second engaging part”) and the pair of surfaces 95A and 95B (an example of a “tapered part”) guiding each of the ribs 123B to the position at which each of the ribs 123B engages with one of the cutouts 95 are also an example of the “rotation transmitting part”.

A procedure of detaching the install part 60 from the supporting mechanism 80 will be explained in the following.

Firstly, in a state that the install part 60 is installed in the supporting mechanism 80 (the state depicted in FIG. 5), the moving member 85 is pushed downward. With this, the moving member 85 is moved downward against the biasing force of the coil spring 86. As a result, the bottom part 85A of the moving member 85 is located at a position below the pair of projected parts 63D of the right side plate 63 of the install part 60. With this, the install part 60 is slidable rightward.

Note that due to the downward movement of the moving member 85, the interlocking mechanism 66 (see FIG. 6) is moved downward due to the self-weight thereof. This makes possible to detach the holder 35 from the install part 60.

Then, by sliding the install part 60 rightward, the install part 60 is detached from the supporting mechanism 80, and is pulled out to the outside of the casing 30 via the opening 32 (see FIG. 1).

Note that by the rightward moving of the install part 60, the joint part 123 of the holder 35 is pulled out from the shaft 82 along the axis 82A of the shaft 82. Further, the ribs 123B of the joint part 123 of the holder 35 are pulled out from the columnar body 94 of the gear 83. With this, there is provided a state that the joint part 123 is moved downward, and that the joint part 123 is supported by the bottom surface 67A constructing the cutout 67 of the left side plate 62 of the install part 60. Namely, there is provided a state that the joint part 123 is temporarily supported by the bottom plate 67A.

### Effects of Embodiment

According to the above-described embodiment, the holder 35 supporting the roll body 37 is attached and detached with respect to the supporting mechanism 80 along the axis 82A of the shaft 82. The roll body 37 is moved parallel to the axis 82A, and does not move in the radial direction of the shaft mechanism 51 of the holder 35. Accordingly, there is no need to secure a space, in the casing 30, for allowing the roll body 37 to pass in the radial direction of the shaft mechanism 51 of the holder 35. Accordingly, it is possible to realize a reasonable layout inside the casing 30 and thus to realize a small-sized casing 30.

Further, according to the above-described embodiment, each of the ribs 123B is guided by the pair of surfaces 95A and 95B to a position at which each of the ribs 123B engages with the columnar body 94. Accordingly, it is possible to engage the ribs 123B and the columnar 94 with each other in an assured manner. With this, it is possible to transmit the rotation of the gear 83 to the shaft mechanism 51 in an assured manner.

Furthermore, in a case of installing the roll body 37 in the casing 30 while grasping the roll body 37, there is such a fear that the sheet S constructing the roll body 37 might become unwound (unreeled, loose). Moreover, in a case of installing the roll body 37 in the casing 30 while grasping the holder 35 at the both end parts in the left-right direction 9 of the roll body 37, since the roll body 37 is not grasped, it is possible to prevent the sheet S from being unwound or becoming loose. However, since the roll body 37 and the holder 35 are installed in the casing 30 along the axis 82A of the shaft 82, namely along the left-right direction 9, it is necessary that one of the hands that is grasping the holder 35 is placed at a far part of the casing 30 during the process of the installing. Accordingly, the installing of the holder 35 becomes difficult, and an additional space for placing the hand in the rear part of the holder 35 is required, as well. In the present embodiment, however, it is possible to grasp the install part 60 in a state that the holder 35 is supported by the install part 60, and to install the install part 60 in the supporting mechanism 80 which is in the inside of the casing 30. Accordingly, there is no need to grasp the roll body 37 and the holder 35, and only a part, of the install part 60, which is positioned on the front side with respect to the casing 30 is grasped and the install part 60 can thereby be installed in the supporting mechanism 80 along the left-right direction 9.

Further, according to the present embodiment, the joint part 123 is separated away from the bottom part 67A constructing the cutout 67 in the install state (the state depicted in FIGS. 4 and 5). Accordingly, it is possible to reduce a contact location at which the shaft mechanism 51 and the install part 60 make contact with each other in the install state, it is possible to rotate the shaft mechanism 51 smoothly.

Furthermore, according to the above-described embodiment, it is possible to prevent the right end of the shaft 120 of the shaft mechanism 51 from being detached from the bearing 64, by locking of the locking mechanism 65.

Moreover, according to the above-described embodiment, it is possible to performing not only the locking of the install part 60 with respect to the supporting mechanism 80, but also performing the locking of the right end of the shaft 120 of the shaft mechanism 51 with respect to the bearing 64, by allowing the install part 60 to be installed in the supporting mechanism 80.

Further, according to the above-described embodiment, the second externally fitting part 122 of the shaft mechanism 51 is rotated relative to the right flange 53 and the leaf spring parts 128 are guided to the outside in the radial direction, thereby allowing the leaf spring parts 128 to make contact with the roll body 37 and to push the roll body 37 toward the outside in the radial direction. With this, the position of the roll body 37 with respect to the holder 35 can be stabilized.

<Modifications>

In the above-described embodiment, although the gear 83 corresponds to the rotary body, the rotary body is not limited to or restricted by being the gear 83. It is allowable, for example, that a pulley is arranged, instead of the gear 83. In such a case, for example, the driving transmitting mechanism 105 has at least one pulley and an endless ring-shaped belt. Further, the belt is stretched between the pulley as the rotary body and the pulley possessed by the driving transmitting mechanism 105.

In the above-described embodiment, the second externally fitting part 122 includes the projected parts 124, and the right flange 53 includes the leaf spring parts 128. It is allowable, however, that the right flange 53 includes the projected parts 124 and the second externally fitting part 122 includes the leaf spring parts 128, contrary to the above-described embodiment.

The mechanism constructed of the projected parts 124 and the leaf spring parts 128 may be provided on the side of the left flange 52, rather than on the side of the right flange 53, or may be provided on the both sides which are the right flange 53 and the left flange 52.

In the above-described embodiment, the gear 83 is a separate member from the shaft 82, and is rotatable about the axis 82A of the shaft 82. It is allowable, however, that the shaft 82 and the gear 83 may be formed as an integrated body.

In such a case, different from the above-described embodiment, the shaft 82 is rotatably supported by the bent plate 81F, rather than being fixed to the bent plate 81F.

Further, in this case, the ribs 123B of the joint part 123 may be configured to be connected or linked to the shaft 82, rather than to the gear 83 (columnar body 94).

The configuration for transmitting the rotation from the gear 83 to the shaft mechanism 51 is not limited to the configuration, such as the above-described embodiment, wherein the ribs 123B are fitted into the cutouts 95, respectively, and may adopt a variety of kinds of publicly known configurations.

Further, it is allowable that the supporting mechanism 80 has a shape supportable by the shaft 82; the specific shape of the supporting mechanism 80 is not limited to or restricted by the shape depicted, for example, in FIG. 3, etc. For example, in the supporting mechanism 80, it is allowable to use a block of which shape is a rectangular parallelepiped, instead of using the frame 81.

Furthermore, it is allowable that the install part 60 may have a shape different from the shape depicted in FIG. 4, etc., under a condition that the install part 60 has the bearing 64 and that the shape of the install part 60 is a shape attachable/detachable with respect to the supporting mechanism 80.

The opening 32 of the casing 30 may be formed in a part, of the casing 30, which is different from the right surface 30R.

In the above-described embodiment, the holder 35 is installed in the install part 60, and the install part 60 having the holder 35 installed therein is installed in the supporting mechanism 80. It is allowable, however, that the image recording apparatus 100 is not provided with the install part 60, and that the holder 35 is directly installed in the supporting mechanism 80. In such a case, for example, it is allowable that the shaft 82 provided on the supporting mechanism 80 extends more rightward than the above-described embodiment; and that the shaft 120 provided on the holder 35 is configured to be shorter than that in the above-described embodiment, and is provided only on the right end of the shaft mechanism 51. Further, in a case that the holder 35 is installed in the supporting mechanism 80, it is allowable that the holder 35 is inserted into the casing 30 while being slid leftward so that the shaft 82 of the supporting mechanism 80 is inserted into the inside of the shaft mechanism 51 of the holder 35. With this, there is provided a state wherein the shaft mechanism 51 is supported by the shaft 82, and the holder 35 is installed in the supporting mechanism 80.

In the above-described embodiment, the conveying roller pair 36, the conveying roller pair 40 and the conveying belt 101 correspond to the “conveyor”. The conveyor, however, is not limited to or restricted by being the conveying roller pair 36, the conveying roller pair 40 and the conveying belt 101. It is allowable, for example, that the conveyor is not provided with any roller pair, and that the conveyor is constructed only of one piece or a plurality of pieces of a conveying belt. Alternatively, it is allowable, for example, contrary to the foregoing that the conveyor is not provided with any conveying belt, and that the conveyor is constructed only of one piece or a plurality of pieces of a roller pair. Of course, it is allowable that the conveyor is provided with both of the roller pair and the conveying belt. For example, it is allowable that the conveyor is provided with the conveying belt, instead of the conveying roller pairs 36 and 40, and/or is provided with a roller pair instead of the conveying belt 101.

The sheet S may take a configuration different from that in the above-described embodiment, under a condition that the sheet S is continuous. For example, the sheet S may have perforations so that the sheet S can be cut manually. In such a case, it is allowable that the image recording apparatus 100 is not provided with the cutter unit 26.

In the above-described embodiment, although the image recording apparatus 100 records an image on a sheet by the ink-jet system, it is allowable that a printing system of the electro-photographic system is adopted, or a thermal head is adopted, instead of adopting the ink-jet system. In such a case, the tank 34 is omitted.

In the above-described embodiment, the image recording apparatus 100 which performs recording on the sheet S is explained, as an example of the conveying apparatus. The conveying apparatus, however, is not limited to the image recording apparatus 100, and may be an apparatus which conveys the sheet S (for example, a scanner).

What is claimed is:

1. A conveying apparatus comprising:
a casing;
a motor;
a supporting part positioned in the casing;
a first shaft supported by the supporting part;
a rotary body configured to rotate about an axis of the first shaft;
a driving transmitting part configured to transmit a driving force from the motor to the rotary body;
a holder configured to support a roll of a continuous sheet, configured to be detachably attached to the first shaft, and configured to rotate about the axis of the first shaft;
a rotation transmitting part configured to transmit rotation of the rotary body to the holder; and
a conveyor positioned in the casing and configured to convey the continuous sheet,
wherein the holder includes:
a second shaft configured to be inserted into the roll of the continuous sheet, and
a joint positioned on one end of the second shaft, configured to move along the axis of the first shaft, and configured to attach the second shaft to the first shaft detachably such that the second shaft is coaxially with the first shaft; and
in an attached state in which the second shaft is attached to the first shaft, the rotation transmitting part connects the second shaft to the first shaft or the rotary body so as to transmit the rotation of the rotary body to the second shaft.

2. The conveying apparatus according to claim 1, wherein in the attached state, the rotation transmitting part connects the second shaft to the rotary body so as to transmit the rotation of the rotary body to the second shaft.

3. The conveying apparatus according to claim 1, wherein the joint has a cylindrical shape, and is configured to externally fit to the first shaft; and
the rotation transmitting part includes:
a first engaging part provided on a circumferential surface of the joint,
a second engaging part provided on the first shaft or the rotary body, the second engaging part engaging with the first engaging part in the attached state, and
a tapered part which guides one of the first engaging part and the second engaging part in a radial direction of the first shaft, in a process in which the second shaft is attached to the first shaft, to a position at which one of the first engaging part and the second engaging part is engaged with the other of the first engaging part and the second engaging part.

4. The conveying apparatus according to claim 3, wherein the second engaging part and the tapered part are provided on the rotary body.

5. The conveying apparatus according to claim 1, further comprising an install part configured to be detachably installed in the supporting part, the install part including a bearing configured to detachably support the other end of the second shaft.

6. The conveying apparatus according to claim 5, wherein the install part includes a temporary supporting part configured to support the one end of the second shaft;
in a process in which the install part is installed in the supporting part, the temporary supporting part positions the one end part of the second shaft to a position at which the one end of the second shaft is attachable to the first shaft; and
in the attached state, the one end of the second shaft is away from the temporary supporting part.

7. The conveying apparatus according to claim 5, wherein the install part includes a first locking part configured to lock the other end of the second shaft in a first lock state in which the other end of the second shaft is supported by the bearing.

8. The conveying apparatus according to claim 7, further comprising:
a second locking part configured to lock the install part in a second look state in which the install part is installed in the supporting part; and
an interlock configured to interlock the first locking part with the second locking part so as to maintain the first locking part in the first lock state in conjunction with a locking operation of the second locking part.

9. The conveying apparatus according to claim 8, wherein the second locking part is provided on the supporting part.

10. The conveying apparatus according to claim 8, wherein the interlock is provided on the install part.

11. The conveying apparatus according to claim 1, wherein the holder includes a flange externally fitted around the second shaft to be rotatable;
one of the second shaft and the flange includes a moving part which is positioned in the roll of the continuous sheet and which is movable in a radial direction of the second shaft in a state that the holder supports the roll of the continuous sheet; and
the other of the second shaft and the flange includes a cam surface, wherein the cam surface is configured to make contact with the moving part so as to guide the moving part to outside of the radial direction, in a case that the other of the second shaft and the flange rotates relative to the one of the second shaft and the flange.

12. The conveying apparatus according to claim 11, wherein the roll of the continuous sheet includes a core tube having the continuous sheet wound around in a roll shape in a circumferential direction of the core tube; and
in the state that the holder supports the roll of the continuous sheet, the moving part makes contact with an inner wall of the core tube such that the moving part presses the inner wall of the core tube toward the outer side in the radial direction of the second shaft.

13. The conveying apparatus according to claim 11, wherein the moving part is provided on the flange; and
the cam surface is provided on the second shaft.

14. The conveying apparatus according to claim 1, wherein the rotary body is a gear.

15. The conveying apparatus according to claim 1, wherein the first shaft and the rotary body form an integral member.

16. The conveying apparatus according to claim 15, wherein in the attached state, the rotation transmitting part connects the second shaft and the first shaft to each other such that the rotation transmitting part transmits the rotation of the rotary body to the second shaft.

17. A printing apparatus comprising:
the conveying apparatus as defined in claim 1; and
a printing part configured to perform printing on the continuous sheet conveyed by the conveyor.
